(19) United States
(12) Patent Application Publication
(10) Pub. No.: US 2016/0308980 A1
(43) Pub. Date: Oct. 20, 2016

(54) SYSTEM AND METHOD FOR SEAMLESSLY TRANSITIONING DEVICE-BASED INTERACTION

(71) Applicant: 24/7 CUSTOMER, INC., Campbell, CA (US)

(72) Inventors: Tajinder SINGH, Santa Clara, CA (US); James Ming LI, Piedmont, CA (US); Andrew CHANG, Palo Alto, CA (US)

(21) Appl. No.: 15/100,975

(22) PCT Filed: Dec. 1, 2014
(86) PCT No.: PCT/US14/67978

§ 371 Date: Jun. 1, 2016

Related U.S. Application Data
(60) Provisional application No. 61/910,923, filed on Dec. 2, 2013.

(51) Int. Cl. H04L 29/08; H04M 1/725; H04W 12/06

(52) U.S. Cl. CPC H04L 67/148; H04W 12/06; H04L 67/02; H04M 1/72583

(57) ABSTRACT

A technique for seamlessly transitioning a process on a particular device and/or a particular channel to at least one other different device and/or channel is provided. Specifically, a user can begin a process, referred to herein as a device-based interaction, on a first device and/or channel. For example, the user can begin to type a text message on a mobile phone. By way of a networked server, the user can indicate a desire to continue the process, such as the text message, on a different device, such as a television. Subsequent to indicating the desire to continue the process on the second device, such as the television, the user can access the television and continue the process, such as the text message, on the television. The technique can be used to authenticate the user on the second device as well as uniquely identify the particular device-based interaction.

### CROSS REFERENCE TO RELATED APPLICATIONS

This patent application is a 35 U.S.C. §371 National Stage application of International Patent Application No. PCT/US14/67978, entitled SYSTEM AND METHOD FOR SEAMLESSLY TRANSITIONING DEVICE-BASED INTERACTION, filed Dec. 1, 2014, which claims the benefit of U.S. Provisional Patent Application No. 61/910,923, entitled SYSTEM AND METHOD FOR SEAMLESSLY TRANSITIONING DEVICE-BASED INTERACTION, filed Dec. 2, 2013, the entirety of each which is incorporated herein by this reference thereto.

### BACKGROUND

1. Technical Field

The present technique generally relates to the field of communication devices. More specifically, the technique relates to particularly to seamlessly transitioning a device-based interaction from one communication device and/or communication channel to another communication device and/or communication channel.

2. Description of the Related Art

With rapid advancement in technology, an increasing amount of human interaction is being facilitated using electronic devices like Smartphones, laptops, tablet personal computers (PCs) and the like. Most individuals nowadays typically possess more than one such electronic device. Apart from facilitating personal and professional interaction, these electronic devices may also be utilized for interactions related to customer support services. Examples of such a type of interaction may include interactions for payments, for products/services information exchange, for resolving concerns and the like. In certain scenarios, a customer may need to continue his/her interaction on another device. In such cases, a customer has to restart the customer service and/or sales experience. For example, if a user has provided a credit card number in a financial interaction facilitated through a website and subsequently decides to transition the interaction to an interactive voice response (IVR) interface, then the customer has to re-authenticate herself/himself and re-establish the context by providing the same credit card information to further the interaction, which may be cumbersome and frustrating for the customer.

### BRIEF DESCRIPTION OF THE DRAWINGS

FIG. 1 is a schematic diagram of a networked environment to implement a seamless transition from one device or communication channel to another device or communication channel, according to an embodiment;

FIG. 2 is a schematic diagram depicting a seamless transition of a device-based interaction from a first device to a second device and then to a third device, according to an embodiment;

FIG. 3 is a schematic diagram of an authentication mechanism used in seamless transitioning of a device-based interaction from one device to another device, according to an embodiment;

FIG. 4 is a flow diagram of a method for transitioning a device-based interaction, according to an embodiment; and

FIG. 5 is a block schematic diagram showing a machine in the example form of a computer system within which a set of instructions for causing the machine to perform one or more of the methodologies discussed herein may be executed.

### DETAILED DESCRIPTION

A technique for seamlessly transitioning a process on a particular interface on a particular device and/or on a particular channel to at least one other different device and/or channel is provided. Specifically, a user can begin a process on a particular interface, referred to herein as a device-based interaction, on a first device and/or channel. For example, the user can begin to type a text message on the interface at a mobile phone. Other examples of device-based interactions include but are not limited to various forms such as an online chat, a phone conversation with an agent, a web page based interaction and the like. By way of a networked server, the user can indicate a desire to continue the process, such as the text message, on the interface but at a different device, such as a television. Subsequent to indicating the desire to continue the process on the second device, such as the television, the user can access the television, access the particular interface, and continue the process, such as the text message, on the television. The technique can be used to authenticate the user on the second device as well as uniquely identify the particular device-based interaction.

In some embodiments, the term, device-based interaction, as used herein refers to an interactive process initiated on the device. For example, a device-based interaction specifically can refer to a customer interaction with a customer support interface using an electronic device, preferably connected to the Internet, such as a mobile phone, a smartphone, a laptop, a tablet PC, a device console in a vehicle, a television and the like. The device-based interaction may be facilitated over one or more channels, such as an online channel (i.e. through web medium) or via a cellular channel (for example, accessing an IVR interface by a Smartphone) and the like. Techniques disclosed herein enable customers to seamlessly continue a device-based interaction with a customer support interface while transitioning to one or more devices and/or communication channels.

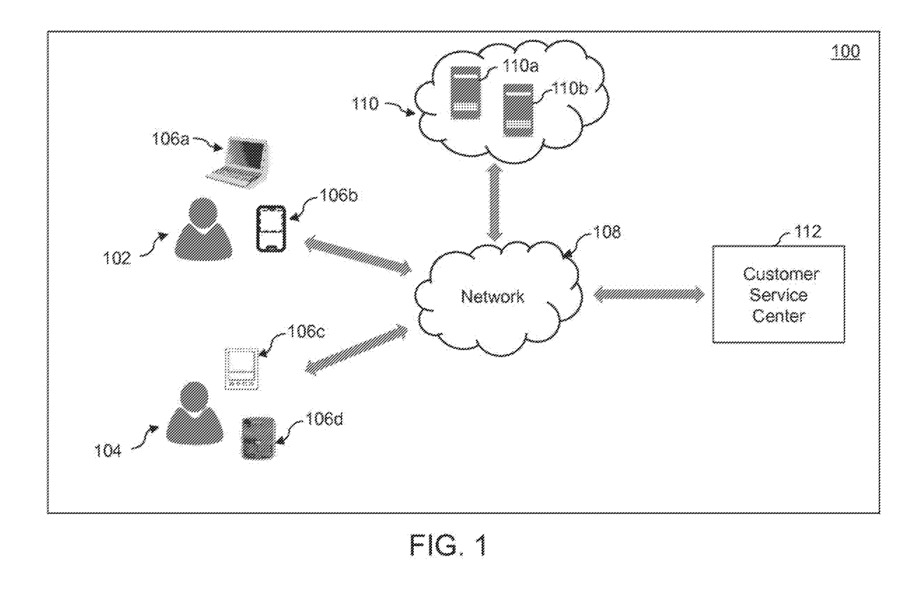

FIG. 1 illustrates an exemplary environment 100 in which various embodiments of the present technology may be practiced. The environment 100 depicts a first user 102 and a second user 104. Each user is associated with a plurality of electronic devices. For example, the user 102 is associated with electronic devices, such as a laptop 106a and a mobile phone 106b, and, the user 104 is associated with electronic devices, such as tablet personal computer (PC) 106c and a Smartphone 106d. It should be appreciated that the environment 100 is depicted to include only two users for exemplary purposes and that the environment 100 may include a plurality of users, such as the users 102 and 104. The electronic devices 106a, 106b, 106c and 106d are hereinafter collectively referred to as devices and singularly referred to as a device.

In an embodiment, each device is configured to facilitate a user interaction, e.g. a device-based interaction, with a remote customer service center 112 over a network 108. Examples of the network 108 may include wired networks, wireless networks or a combination thereof. Examples of wired networks may include Ethernet, local area network (LAN), fiber-optic cable network and the like. Examples of wireless network may include cellular networks like GSM/3G/CDMA networks, wireless LAN, blue-tooth or Zigbee networks and the like. An example of a combination of wired and wireless networks may include the Internet. In some embodiments, the devices may include native applications, web based applications and/or hybrid applications, which may include customer service modules configured to facilitate device-based interaction with the remote customer service center 112.

The network 108 may be associated with, and in some cases may include, a storage facility in the form of cloud 110. The cloud 110 may include one or more web servers, such as web servers 110a and 110b, configured to store content-related data associated with users and business entities. For example, the cloud 110 may be configured to store user related data such as regarding devices associated with a user (for example, devices 106a and 106b associated with user 102), history of device-based interactions of the user, and information associated with the user (for example, credit card details, frequent flyer numbers etc.). Interaction is stored using an interaction data model (IDM), i.e. a standardized data format across channels. IDM is a data structure. For example, suppose chat is flicked to a phone call because a user is unable to continue typing because the user is now on the move. The interaction data in this case is previous channel information (e.g. device=desktop, timestamps=interaction start/pause, interaction duration, task type (e.g. purchase of a device), ip, and location). The interaction data is used to resume the experience over a phone/voice channel such that the user does not have to restart the conversation. In an embodiment, the cloud 110 may also be configured to store an on-going device based interaction. The users, such as users 102 and 104, may access the cloud 110 through the network 108.

In an embodiment, a user may initiate a device-based interaction with the customer service center 112 using any one of the devices. However, the user may wish to transition the on-going device-based interaction to another device or to another channel. For example, user 102 may wish to transition the device-based interaction from laptop 106a to mobile phone 106b, or, user 104 may wish to transition the device-based interaction from tablet PC 106c to Smartphone 106d for a variety of reasons, such as, for example, for mobility, convenience, etc.

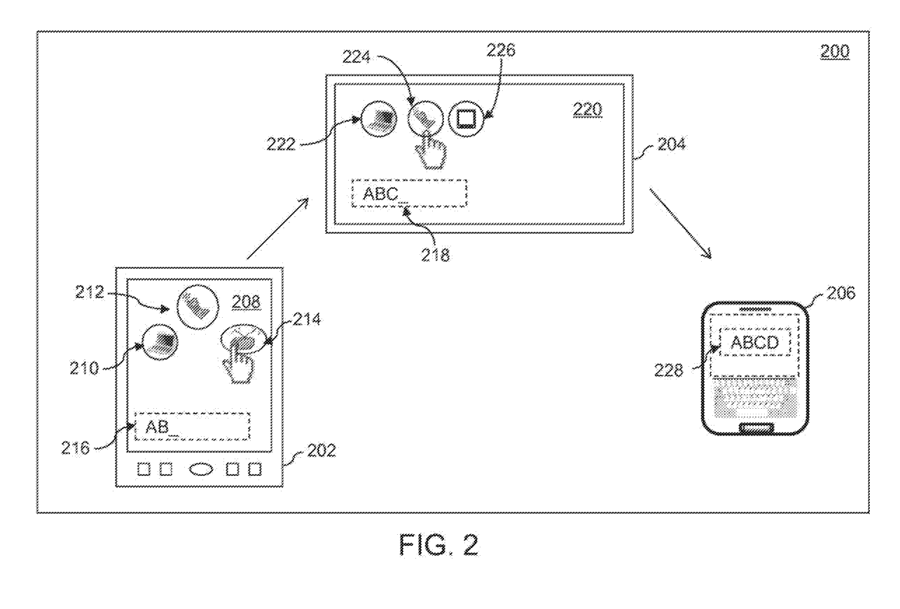

In an embodiment, the user may wish to transition a communication channel along with the device. For example, user 102 may wish to transition a phone conversation with a customer service center agent to an online chat or vice versa. In such cases, a flow of communication is uninterrupted and seamlessly transitioned from one device to another or from one channel to another. The seamless transitioning of device-based interaction is further explained with reference to FIG. 2.

Referring now to FIG. 2, a visual representation 200 illustrating an embodiment of a seamless transition of a device-based interaction is depicted. As explained herein with reference to FIG. 1, users, such as users 102 and 104 may use one or more devices for engaging in a device-based interaction with customer service center 112. Further, users may wish to transition to devices during an on-going device-based interaction. In FIG. 2, an example device-based interaction of sending a character string ‘ABCD’ to a remote customer service center, such as customer server center 112 of FIG. 1, while changing devices is considered to illustrate the seamless transition aspect. In an embodiment, the user is able to resume sending of data from one device/channel and then from another device/channel, in a seamless transition fashion. The seamless transition of a device-based interaction also includes seamless transition of a dialogue or an interaction over to another device/channel. For example, if a dialogue concerning a resolution of a customer concern involves five steps, then the first two steps may be performed on a first device and the remaining steps may be continued over another device/channel, such as a chat session on a mobile phone.

Accordingly, FIG. 2 depicts three exemplary devices, a tablet PC 202, a smart television 204 and a mobile phone 206 that are associated with a single user and that are used for engaging in a device-based interaction with the remote customer service center. The user associated with the devices 202, 204 and 206 may initiate a device-based interaction with the customer service center, using the tablet PC 202. During an on-going device-based interaction, the user may wish to transition to the device-based interaction on the smart television 204. In an embodiment, a plurality of icons may be displayed on a display screen 208 of the tablet PC 202 which may facilitate transitioning of the device-based interaction to another device. In an embodiment, each icon of the plurality of icons may correspond to a device, e.g. other than the current device, for example the tablet PC 202, associated with the user. In some embodiments, the plurality of icons may include icons corresponding to devices associated with other users, for example, family and/or within social circle of the user.

In an embodiment, each icon is embedded within the experience from which a user can transition. For example, in the cited example, the chat frame/window is powered with a ‘device flick’ icon, such as a phone icon, suggesting transitions, such as to a phone. Clicking the icon activates the device flick service configured for that specific chat experience for that specific client. As well, the configuration could be based on other parameters such as specific journey. In the above example, the service generates an outbound call with the interaction data to ‘resume’ the task that the user ‘paused’. Further, in the outbound phone call the user is prompted for “resumption” of service, e.g. “we will continue purchase of xyz item that you initiated in the <previous channel>”.

Implementation mechanisms for achieving these interactions include but are not limited:
The icon passes the data structure and context for the previous interaction;
The icon also indicates which channel to which to be transferred, e.g. phone; and
The icon sends the information to the interaction server for the selected channel.

In FIG. 2, the plurality of icons displayed on the display screen 208 of the tablet PC 202 includes an icon 210 corresponding to a laptop, an icon 212 corresponding to a mobile phone and an icon 214 corresponding to a smart television. Each of these icons 210-214 correspond to devices associated with the user (or other users associated with the user). It should be appreciated that the plurality of icons are depicted herein for exemplary purposes and that the display screen 208 may be configured to display icons in any other format (for example, textual listing as opposed to visual icons) or position (for example, any side-portion or bottom-portion of the display screen 208). Further, the plurality of icons may be displayed from the beginning of the device-based interaction or may pop-up upon reception of an indication to transition to another device from the user. Each device that appears within each icon is based on one or more observed interactions from each of those devices. For example, the user has used the phone number of the device in the past to make a call. Alternatively, a user can be prompted to select or enter the transferee phone number.

In an embodiment, the user may selectively flick or click on the displayed icon to transition to other devices. For example, in FIG. 2, the user is depicted to flick/click on the icon 214 indicating the user's intent to continue the device-based interaction from the tablet PC 202 to the smart television 204. Accordingly, the device-based interaction may transition to the Smart television 204. In FIG. 2, the device-based interaction is depicted to include provisioning of textual content (as depicted by text box 216) in form of characters being typed, such as characters “A” and “B”. The device-based interaction upon being transitioned onto the smart television 204 may be continued and the textual content may be further added to, as depicted by addition of character “C” in text box 218 displayed on display screen 220 of the smart television 204. The display screen 220 of the smart television 204 further depicts a plurality of icons, such as icon 222 corresponding to a laptop, an icon 224 corresponding to a mobile phone and an icon 226 corresponding to a tablet PC. The user may further wish to continue the on-going device-based interaction on the mobile phone 206 and accordingly may flick/click on the icon 224 as depicted in FIG. 2. Upon flicking/clicking on the icon 224, the device-based interaction may be seamlessly transitioned to the mobile phone 206. More specifically, the user may continue the device-based interaction by adding a character “D” (as depicted by text box 228) to complete the string of characters “ABCD”. A task is communicated in a set of slots. In the case here, ABCD is an example of four slots, each containing “A”, “B”, “C”, and “D”, respectively. Another example of slots is address, name, credit card information, model of phone, data plan, and color of phone, for example, regarding purchasing a phone. If while on the previous channel the user fills up the first four slots: address, name, credit card information, and model of phone, then the interaction server of the transferee channel obtains or accesses this data and resumes the conversation, for example, to obtain the remaining information, data plan and color of phone, to complete the conversation or purchase order in this case. The transferring of channels/devices succeeds when the intent of the user is known. In an embodiment, the device flick icon appears after the context is known. However, when based on just journey data, an interaction can be resumed from where it was left in a previous channel/device, even without context.

As can be seen by the above example, the user does not need to restart the device-based interaction and the flow of communication is uninterrupted while transitioning from devices and/or channels to other devices and/or channels, thereby ensuring seamless transitioning of the device-based interaction. The seamless transition of the device-based interaction is dependent upon authentication of the user and maintenance of context of the device-based interaction.

In an embodiment, the user may pre-authorize the devices that are to be utilized for device-based interaction. For example, the user may register the tablet PC 202, the smart television 204 and the mobile phone 206 for device-based interaction with a customer service center, such as the customer service center 112 of FIG. 1. In an embodiment, registration of the devices may be performed on the fly or in an offline mode. An example of the on-the-fly mode may be a callback, where the user is prompted to enter relevant information for desired next device/channel. For example, when the user is utilizing a browser on the tablet PC 202 to interact with the customer service center and the user intends to transition to the mobile phone 206, he/she may perform a click/flick on the icon 208 and a pop up window (not shown in FIG. 2) may be displayed on the display screen 208 requesting the user to enter a number of a mobile phone (for example, “123-456-6789” of mobile phone 206) on which the user would like to continue the device-based interaction. Upon provisioning of such information, the device-based interaction may be seamlessly transitioned onto the mobile phone 206. Other examples of candidate transferees include but are not limited to Web browser, native mobile apps, email, TV, a connected car, wearable devices, etc. In an embodiment, the cloud 110 of FIG. 1 may store the on-going device-based interaction in addition to storing information such as that related to registered devices associated with the user and an association between the registered devices. In an embodiment, the registered devices may be linked or associated with each other using parameters, such as a phone number, user identification (ID), a customer ID and the like. In an embodiment, such information stored in the cloud 110 may enable establishing the context upon transitioning the devices. Accordingly, the user may be precluded from both re-authentication and re-establishing the context while continuing the device-based interaction on another device, thereby facilitating on the fly authentication.

In an embodiment, the customer service center may allot a session identifier for the on-going device-based interaction if the user intends to transition the device he/she is using to another device with a different communication channel. For example, if the user has requested a service (for example, a video conferencing application) for a product over the smart television 204 and if the user is unable to listen to the device-based interaction associated with the service due to a poor quality of the audio, then the user may choose to transition to another device, such as to the mobile phone 206. The user may indicate his/her intent to transition to another device by flicking/clicking an icon from among the plurality of displayed icons as explained above. The customer service center may allot a unique session identifier that is displayed on the display screen 220 of the smart television 204 and requests the user to enter the session identifier in the mobile phone 206 to continue the device-based interaction. The session identifier may be an alphanumeric code, a numeric code, a word, an audio song, an image and/or a combination of the above to authenticate the identity of the user to continue the device-based interaction. For instance, the customer service center displays an alphanumeric code, such as ‘qW19zC’, on the display screen 220 of the smart television 204 when the user requests to transition the device-based interaction to the mobile phone 206. The user enters the alphanumeric code ‘qW19zC’ on the mobile phone 206 upon establishing a contact with the customer service center. In an embodiment, the session identifier may authenticate the user on the mobile phone 206 and uniquely identify the device-based interaction. The context may further be established by receiving the device-based interaction stored on the cloud 110 (shown in FIG. 1) thereby precluding the hassle to re-establish the context. In an embodiment, the device-based interaction may be stored at a storage facility at the customer service center itself precluding the need to use the cloud 110. In another embodiment, the cloud 110 may be provisioned by the customer service center for facilitating storing of on-going device based interactions.

In an embodiment, the session identifier is randomly generated or procedurally generated in an orderly fashion. In an embodiment, when the user transitions to a new device, the preceding device detects that the user has logged into the new device and asks the user if the user wants to continue the device-based interaction on the new device and end the device-based interaction on the preceding device. For example, when the user enters the session identifier into the mobile phone 206, the smart television 204 may detect that the user has logged onto the mobile phone 206 and a message may be sent to the mobile phone 206 inquiring if the user wants to end the device-based interaction on the smart television 204. In an embodiment, the process is initiated by the user and subsequently the server reaches out, e.g. via the most appropriate method, to the selected channel. Based on the channel selected the data request is sent to an appropriate server, e.g. web server, IVR server, etc. Once this request is received, the server initiates the interaction on selected channel/device. Or, the server can resume the interaction by the user opening an application or webpage, or dialing a number for the same service-system, based on the customer data and selected channel preference.

In an embodiment, the user may use a gesture, as requested by the customer service center, to facilitate user authentication on a new device associated with the user. More specifically, the customer service center may direct the user to create a particular pattern on a display of the device associated with the user (for example on the display screen 208 of the tablet PC 202) upon receiving an indication from the user to transition to the smart television 204. The display screen 208 may be configured to receive touch/gesture input. The examples of touch/gesture input may include, but are not limited to, tap, multi-tap, glide, flick, rotation, pinch and the like. In an embodiment, dedicated gesture may be provided by the user, which may be utilized for uniquely identifying and the device-based interaction on the new device (for example, the smart television 204). For example, the user may use a combination of gestures, such as right, front and left to create a pattern to facilitate authentication on the new device.

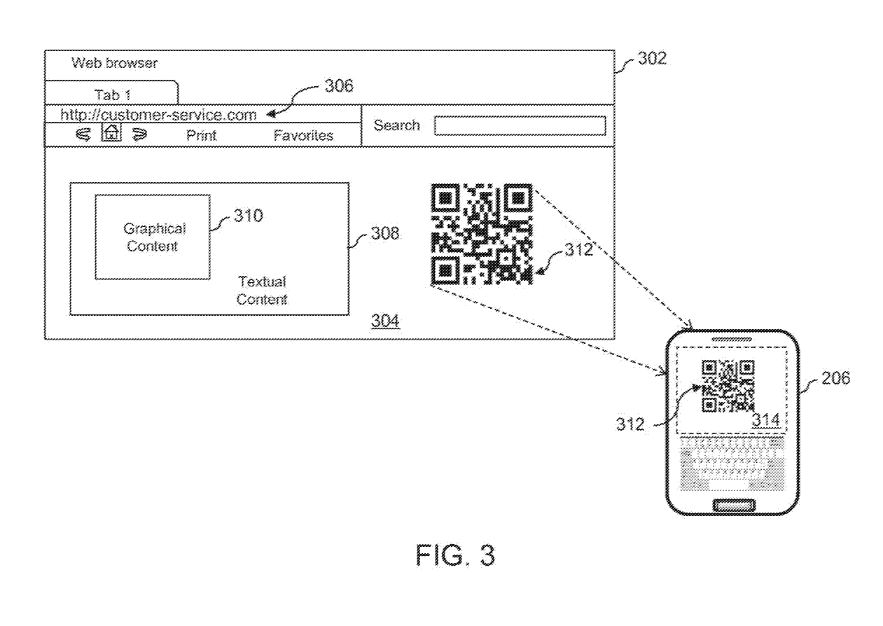

In an embodiment, the customer service center may be configured to provide a link to the user upon receiving an indication from the user for transitioning of devices (for example, an indication such as flicking/clicking an icon as explained above). The link sent to the new device authenticates the user and the device-based interaction may be continued on the new device. In an embodiment, the customer service center may be configured to send the link via electronic mail for authenticating the user. It should be appreciated that such a device-based interaction is included herein for illustrative purposes and that the device-based interaction may include various forms such as an online chat, a phone conversation with an agent, a web page based interaction and the like. In an embodiment, a quick response (QR) code may be utilized for authentication purposes as explained with reference to FIG. 3.

FIG. 3 illustrates an exemplary authentication mechanism for facilitating seamless transitioning of device-based interaction in accordance with an embodiment. As explained with reference to FIG. 2, the user may transition from the smart television 204 to the mobile phone 206 during an on-going device-based interaction. FIG. 3 depicts a web browser 302 facilitating consumption of a web page 304 corresponding to web uniform resource locator (URL) 306 on the display screen 220 of the smart television 204 (not shown in FIG. 3). The web page 304, in addition to displaying a textual content section 308 and a graphical content section 310, depicts a QR code 312. Session data related to the on-going device-based interaction is encoded in form of the QR code 312 (represented in form of black square dots arranged in a square grid on a white background). The user wishing to continue the device-based interaction on the mobile phone 206 via online chat may contact the customer service center and then click a picture of the QR code 312 using an image capture mechanism, such as an image sensor/camera, associated with the mobile phone 206. The captured QR code 312 displayed on a display screen 314 of the mobile phone 206 authenticates the user and also establishes the context of the device-based interaction, thereby precluding the need to reinitiate the device-based interaction on a new device and on a new channel. In an embodiment, the customer service center may generate the QR code 312 upon receiving an indication by the user, such as by flicking/clicking on the icon 224 on the display screen 220 in FIG. 2, for transitioning the device-based interaction to the mobile phone 206.

It should be appreciated that systems/mechanisms for skipping re-authentication and re-establishing of context, such as by authorizing devices, provisioning of session identifiers, QR codes, links, gestures and audio tones, are explained herein for exemplary purposes and that various other mechanisms, such as for example, secure Bluetooth transfer, near field communication (NFC) based transfer etc. may be contemplated to facilitate seamless transition of the device-based interaction. Further, It should be appreciated that the application for such transition of device-based interaction may not be limited to customer support applications alone and may be extended to other applications, such as those related to performing daily routine tasks on web based applications.

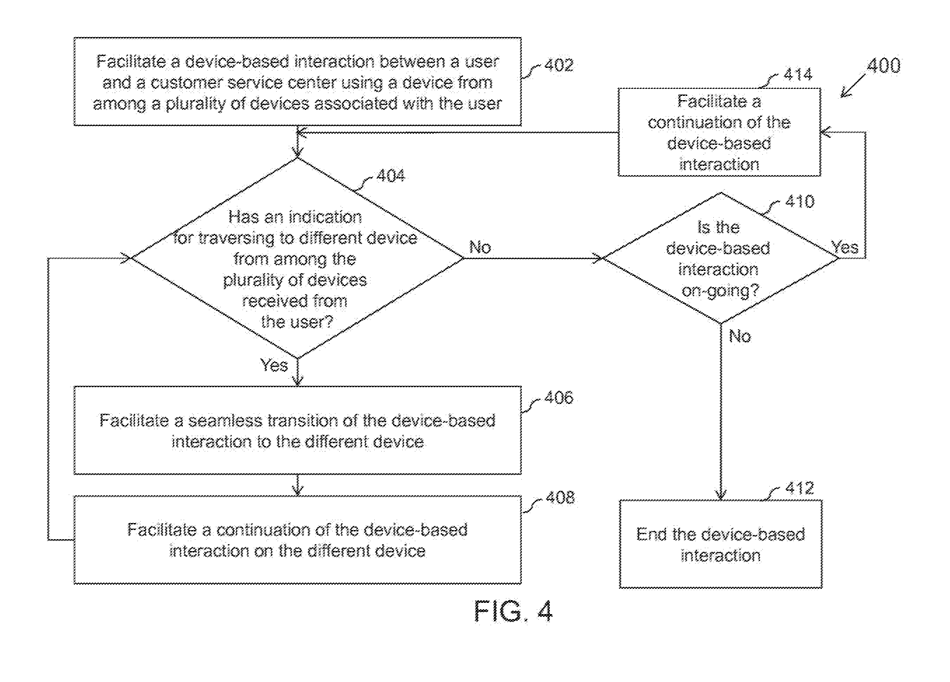

FIG. 4 illustrates a flow diagram of a method 400 for transitioning device-based interaction in accordance with an embodiment. At 402 of method 400, a device-based interaction between a user and a customer service center (such as the customer server center 112 of FIG. 1) is facilitated using a device from among a plurality of devices associated with the user. In an embodiment, the customer service center may be configured to facilitate the device-based interaction by providing, for example, a contact number (e.g. phone number, email address, device id for mobile apps), which the users may use for initiating the device-based interaction. In an exemplary scenario, the customer service center may provide a URL that the user may use to access the web page corresponding to the customer service center for initiating the device-based interaction with the customer service center. As explained with reference to FIGS. 1 and 2, a user may be associated with a plurality of devices. A user may initiate the device-based interaction using any one device from among the plurality of devices associated with the user.

At 404, it is determined, for example, by the customer service center, whether an indication for transitioning to different device from among the plurality of devices is received from the user. A user may wish to transition to a different device for convenience or mobility purposes. For example, a user may wish to transition a device-based interaction, which is initiated online (for example, on a web browser on a tablet PC, desktop or a laptop) to a phone (for example, a mobile phone, a Smartphone or a landline). Alternatively, the user may wish to transition the device-based interaction, which is initiated on phone to a web/online medium. In an embodiment, the user may provide the indication to transition the device by flicking/clicking of icons as explained with reference to FIG. 2.

If it is determined that an indication for transitioning to a different device from among the plurality of devices is received from the user, then at 406, a seamless transition of the device-based interaction to the different device is facilitated. The seamless transition of the device-based interaction may be facilitated by enabling the user to skip re-authentication as well as re-establishing a context of the device-based interaction. As explained with reference to FIGS. 2 and 3, the customer service center in conjunction with the cloud, such as the cloud 110 of FIG. 1, may facilitate the seamless transition by allowing the user to pre-authorize the devices and/or by provisioning a session identifier, a web link, a gesture or a QR code.

Upon seamless transitioning of device-based interaction to the different device, at 408, a continuation of the device-based interaction on the different device may be facilitated. During the on-going device-based interaction, it is determined, at 404, if any further indication for transitioning to different device is received from the user. If it is determined that there is no further indication of transitioning to a yet another device, then at 410, it is determined whether the device-based interaction is on-going. If it is determined that the device-based interaction is completed (i.e. not being continued), then the device-based interaction is terminated at 412. If it is determined that the device-based interaction is still on-going then a continuation of the device-based interaction is facilitated at 414 and the steps at 404 and 410 are repeated at regular intervals till it is determined that the device-based interaction is completed at 410. In an embodiment, each task identified with an intent has a definite beginning and an end. Such identified task is part of the interaction data structure that each channel generates as the user interacts. For example, suppose a user on the web is chatting and trying to buy a phone. The task is ‘phone purchase’. After the interaction is transferred from web/desktop to phone/voice and all slots are completed, an event for task end is generated by the interaction server and the task is completed. The server determines that the device-based interaction is completed based on data structure. The server checks whether all the steps of interaction have been completed and whether information in each slot of the data structure is filled. As well, the system may prompt the user to confirm whether there are any further steps to be processed (“is there anything we can assist you with”). As another example, the system can confirm completion by asking the user to disconnect when he/she is finished.

The techniques disclosed herein enable customers to seamlessly continue a device-based interaction with customer support interface while transitioning devices and/or communication channels. The techniques preclude cumbersome and frustrating task of restarting an interaction upon transitioning an interaction from one device/channel to another device/channel in an uninterrupted manner. Further, a simple flick action or click of a button to transition from a device to another device enhances the experience of the user without having to repeat data for authentication. The user saves time rather than having to answer questions for which he had provided details earlier over a different device. In some embodiments, the authentication may also be facilitated through a previous flick operation, for example, when the user returns back to a device or channel on which he had authenticated recently, e.g. desktop-phone-tablet-phone. In some embodiments, mechanisms, such as security codes, for example, codes based on text, gesture, speech recognition and the like, and/or biometrics, such as for example, techniques involving speech recognition, finger printing and the like, may also be used to facilitate authentication. Furthermore, the user can easily switch to another device immediately or at a time convenient for the user. Further, it should be appreciated that the application for such transition of device-based interaction may not be limited to customer support experiences alone and may be extended to other applications, such as those related to performing daily routine tasks on web-based applications, document processing applications etc., as well.

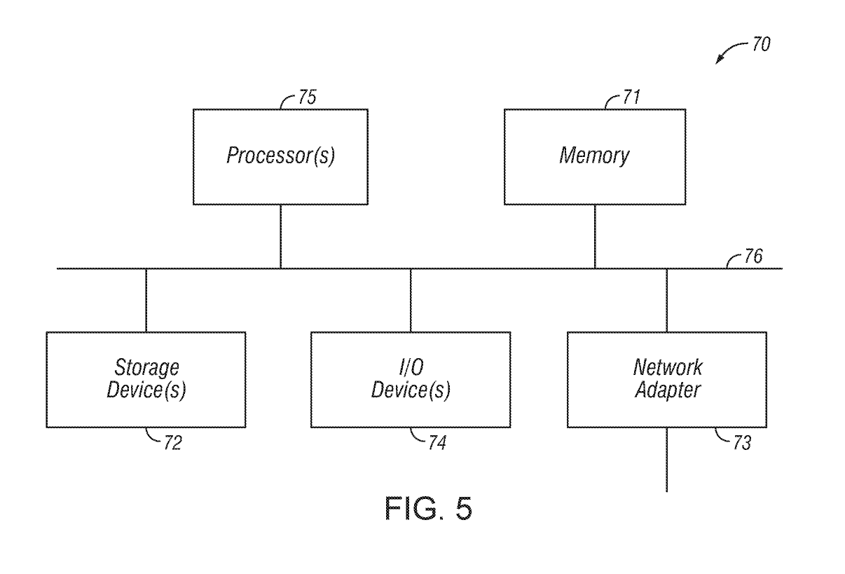

FIG. 5 is a block diagram of a computer system that may be used to implement certain features of some of the embodiments of the invention. The computer system may be a server computer, a client computer, a personal computer (PC), a user device, a tablet PC, a laptop computer, a personal digital assistant (PDA), a cellular telephone, an iPhone, an iPad, a Blackberry, a processor, a telephone, a Web appliance, a network router, switch or bridge, a console, a hand-held console, a (hand-held) gaming device, a music player, any portable, mobile, hand-held device, wearable device, or any machine capable of executing a set of instructions, sequential or otherwise, that specify actions to be taken by that machine.

The computing system 70 may include one or more central processing units (“processors”) 75, memory 71, input/output devices 74, e.g. keyboard and pointing devices, touch devices, display devices, storage devices 72, e.g. disk drives, and network adapters 73, e.g. network interfaces, that are connected to an interconnect 76.

In FIG. 5, the interconnect is illustrated as an abstraction that represents any one or more separate physical buses, point-to-point connections, or both connected by appropriate bridges, adapters, or controllers. The interconnect, therefore, may include, for example a system bus, a peripheral component interconnect (PCI) bus or PCI-Express bus, a HyperTransport or industry standard architecture (ISA) bus, a small computer system interface (SCSI) bus, a universal serial bus (USB), IIC (12C) bus, or an Institute of Electrical and Electronics Engineers (IEEE) standard 1394 bus, also referred to as FireWire.

The memory 71 and storage devices 72 are computer-readable storage media that may store instructions that implement at least portions of the various embodiments of the invention. In addition, the data structures and message structures may be stored or transmitted via a data transmission medium, e.g. a signal on a communications link. Various communications links may be used, e.g. the Internet, a local area network, a wide area network, or a point-to-point dial-up connection. Thus, computer readable media can include computer-readable storage media, e.g. non-transitory media, and computer-readable transmission media.

The instructions stored in memory 71 can be implemented as software and/or firmware to program one or more processors to carry out the actions described above. In some embodiments of the invention, such software or firmware may be initially provided to the processing system 70 by downloading it from a remote system through the computing system, e.g. via the network adapter 73.

The various embodiments of the invention introduced herein can be implemented by, for example, programmable circuitry, e.g. one or more microprocessors, programmed with software and/or firmware, entirely in special-purpose hardwired, i.e. non-programmable, circuitry, or in a combination of such forms. Special-purpose hardwired circuitry may be in the form of, for example, one or more ASICs, PLDs, FPGAs, etc.

Although the innovation is described herein with reference to the preferred embodiment, one skilled in the art will readily appreciate that other applications may be substituted for those set forth herein without departing from the spirit and scope of the present innovation. Accordingly, the innovation should only be limited by the Claims included below.

1. A computer-implemented method to transition a particular device-based interaction, comprising:
providing a first interface either on a first device or over a first channel;
providing a second interface either on a second device or over a second channel;
receiving in the first interface, an indication to transition a device-based interaction, said interaction being performed in first interface, to the second interface;
in response to receiving the indication, authenticating the user;
in response to authenticating the user, presenting the device-based interaction on the second interface; and
maintaining continuity in the device-based interaction when it is transitioned from the first interface and the second interface.

2. The method of claim 1, further comprising:
storing the data of the device-based interaction in a data structure that can be transferred between the first device or first channel and the second device or second channel.

3. The method of claim 1, wherein the first interface comprises a device-flick icon suggesting a transition to the second device or second channel.

4. The method of claim 3, further comprising:
pausing the interaction, in response to the icon being activated, and sending the interaction data to the second device or over the second channel.

5. The method of claim 3, further comprising:
passing interaction data and context of the interaction to an interaction server, in response to the icon being activated; and
indicating to the server the second device or the second channel to which the interaction data and context are to be transitioned.

6. The method of claim 3, further comprising:
presenting a particular device or channel within the icon based on prior interaction over the particular device or channel.

7. The method of claim 3, further comprising:
prompting a user to select a device or channel to which to transition the interaction.

8. The method of claim 1, further comprising:
receiving, at the first device or over the first channel, data regarding a task, where the data comprises a set of data slots to be filled by said task.

9. The method of claim 1, wherein when the slots associated with the task are not filled, an interaction server of the second device or second channel receives such data and resumes the device-based interaction via the second device or over the second channel, enabling the remaining data slots associated with the task to be filled.

10. The method of claim 1, wherein the first device or first channel or second device or second channel comprises any of: mobile device, Web browser, native mobile application, email, television, connected car, and wearable devices.

11. The method of claim 1, further comprising:
resuming the interaction in the second interface in response to a user opening an application or webpage or dialing a number for completing the interaction based on entered customer data and selected device or selected channel preference.

12. An apparatus to transition a particular device-based interaction, comprising:
a first interface either on a first device or over a first channel;
a second interface either on a second device or over a second channel;
at least one processor; and
a memory having stored thereon machine executable instructions, that when executed by the at least one processor, cause the apparatus to:
receive in the first interface, an indication to transition a device-based interaction, said interaction being performed in the first interface, to the second interface;
authenticate the user, in response to receiving the indication;
present the device-based interaction on the second interface, in response to authenticating the user; and
maintain continuity in the device-based interaction when it is transitioned from the first interface to the second interface.
